(19) United States
(12) Patent Application Publication
(10) Pub. No.: US 2006/0062582 A1
(43) Pub. Date: Mar. 23, 2006

(54) Device, system and method for providing visible light information, visible light information reader, program thereof, and computer-readable information storage medium for storing program

(75) Inventors: Shuuji Suzuki, Tokyo (JP); Yoshinori Yoshida, Tokyo (JP)

Correspondence Address: SUGHRUE MION, PLLC, 2100 PENNSYLVANIA AVENUE, N.W., SUITE 800, WASHINGTON, DC, 20037, US

(73) Assignee: NEC CORPORATION

(21) Appl. No.: 11/227,198

(22) Filed: Sep. 16, 2005

(30) Foreign Application Priority Data
Sep. 17, 2004 (JP) 271902/2004

(51) Int. Cl. H04B 10/04

(52) U.S. Cl. 398/183

(57) ABSTRACT

A visible light information providing device, a visible light information reader, a visible light information providing system, a visible light information providing method, a program thereof, and a computer-readable information storage medium for storing the program, enabling a user to recognize the area to which information is provided in a contactless manner. A visible light information providing device comprises a memory, an LED (Light Emitting Diode) for emitting visible light, a modulator circuit for modulating visible light emitted from the LED to transmit information stored in the memory, and a CPU (Central Processing Unit) for controlling the modulator circuit according to the type of information stored in the memory so that the LED emits a prescribed visible light pattern.

### FIELD OF THE INVENTION

The present invention relates to a visible light information providing device, a visible light information reader, a visible light information providing system, a visible light information providing method, a program thereof, and a computer-readable information storage medium storing the program for providing information stored in a storage medium to another device using visible light. More particularly, the present invention is concerned with a visible light information providing device, a visible light information providing system, and a visible light information providing method for enabling a user to learn which area information as an optical signal is to be transmitted to using human-visible light without any special device.

### BACKGROUND OF THE INVENTION

Techniques using a contactless system have come into practical use for forwarding information stored in a storage medium to an external device.

As an representative example of a device with the contactless system may be cited an RF (Radio Frequency) tag reader which reads information stored in a contactless IC card (RF tag) having a nonvolatile memory.

FIG. 1 is a diagram showing the construction of a conventional RF tag system. Referring to FIG. 1, the RF tag system comprises an RF tag 800 and an RF tag reader 900. The RF tag 800 includes a loop antenna 801, an A/D (Analog to Digital) converter 802, a controller 803, a nonvolatile memory 804, and a radio circuit 805. The loop antenna 801 is excited by an electromagnetic wave emitted from the RF tag reader, and generates alternating current. The A/D converter 802 converts the alternating current to direct current to supply it to the controller 803. The controller 803, which has been supplied with power through the loop antenna 801, reads out information stored in the nonvolatile memory 804. Based on the information, the controller 803 converts an electrical signal generated by the radio circuit 805 to a radio signal with the loop antenna 801, thus emitting the radio signal. The RF tag reader 900 receives the radio signal from the RF tag 800, and thereby information stored in the RF tag 800 is forwarded to the RF tag reader 900.

The RF tag system, however, transmits/receives information using radio signals which are imperceptible by human senses. Therefore, the RF tag system has a problem in that a device of some kind is required to learn whether or not the RF tag stores any information or the type of information stored therein.

In Japanese Patent Application laid open No. 2002-236891, there is disclosed a conventional technique entitled “Radio Frequency Tag with Data Display Function” for solving the problem. According to the technique, an RF tag is provided with a display for displaying information, a controller for controlling the display and a battery for supplying power to them so that the RF tag itself can display tag information.

With the RF tag, information stored therein can be recognized by viewing the information displayed on the display without a device such as an RF tag reader.

When information transmitted/received contactlessly requires confidentiality, an information storage medium preferably has a directivity for emitting signals to transmit information so that the leak of information can be prevented.

However, since the radio signal is human-imperceptible, in the case of a system using an RF tag, it is difficult for the users of the system to determine precisely to which extent the radio signal reaches.

The conventional technique mentioned above does not make any consideration of the problem. Besides, the RF tag is necessitated to have such extra functional parts as display, controller and battery, which are unrelated to the intended purpose of the RF tag. These extra functional parts increase the cost of manufacturing the RF tag as well as preventing the RF tag from being miniaturized (smaller and lighter).

As is described above, there has been proposed no information providing system in which a user can recognize the area to which information is provided in a contactless manner.

### SUMMARY OF THE INVENTION

It is therefore an object of the present invention to provide a visible light information providing device, a visible light information reader, a visible light information providing system, a visible light information providing method, a program thereof, and a computer-readable information storage medium for storing the program, enabling a user to recognize the area to which information is provided in a contactless manner.

In accordance with the first aspect of the present invention, to achieve the object mentioned above, there is provided a visible light information providing device comprising an information storage, a light emitter for emitting visible light, a visible light modulator for modulating visible light emitted from the light emitter to transmit information stored in the information storage, and a visible light pattern controller for controlling the light emitter to emit visible light in a prescribed pattern according to the type of information stored in the information storage.

Preferably, in the first aspect of the present invention, the visible light information providing device further comprises a trigger receiver for receiving a trigger signal from an external device. The visible light pattern controller exercises control over the light emitter only when the trigger receiver receives a trigger signal from an external device.

Preferably, in the first aspect of the present invention, when the information storage stores a plurality of types of information, the light emitter emits visible light patterns according to the respective types of the information. In addition, each time a trigger signal is received, or each time a prescribed period of time has elapsed from when a trigger signal was received, information to be provided is changed.

Preferably, in the first aspect of the present invention, when information from an external information source is written to the information storage, the information written to the information storage is provided.

Preferably, in the first aspect of the present invention, the pattern of visible light is represented by the blinking or flashing pattern of light emitted from the light emitter, the color of light emitted from the light emitter, or a combination of the color and blinking pattern of light emitted from the light emitter.

In accordance with the second aspect of the present invention, there is provided a visible light information providing device comprising a network interface, a light emitter for emitting visible light, a visible light modulator for modulating visible light emitted from the light emitter to transmit information, and a visible light pattern controller for controlling the light emitter to create a visible light pattern. The visible light pattern controller controls the light emitter to create a visible light pattern according to the type of information received through the network interface. The visible light modulator transmits information received through a network.

In accordance with the third aspect of the present invention, there is provided a visible light information reader comprising a visible light receiver for receiving modulated visible light, a visible light demodulator for demodulating visible light received by the visible light receiver, and a trigger transmitter for transmitting to a visible light information providing device a trigger signal causing visible light to be emitted in a pattern according to the type of information stored in an information storage in the visible light information providing device.

In accordance with the fourth aspect of the present invention, there is provided a visible light information reader comprising a visible light receiver for receiving modulated visible light, a visible light demodulator for demodulating visible light received by the visible light receiver, and a trigger transmitter for transmitting to a visible light information providing device a trigger signal causing a visible light pattern to be emitted according to the type of information received through a network interface by the visible light information providing device.

In accordance with the fifth aspect of the present invention, there is provided a visible light information providing system comprising: at least one visible light information providing device including an information storage, a light emitter for emitting visible light, a visible light modulator for modulating visible light emitted from the light emitter to transmit information stored in the information storage, a visible light pattern controller for controlling the light emitter to emit visible light in a prescribed pattern according to the type of information stored in the information storage, and a trigger receiver for receiving a trigger signal from an external device; and a visible light information reader including a visible light receiver for receiving modulated visible light, and a visible light demodulator for demodulating visible light received by the visible light receiver. The visible light information reader further includes a trigger transmitter for transmitting a trigger signal to the visible light information providing device. When receiving a trigger signal from the visible light information reader, the visible light information providing device transmits information stored in the information storage under the control of the visible light pattern controller.

Preferably, in the fifth aspect of the present invention, when the information storage stores a plurality of types of information, visible light patterns are emitted according to the respective types of the information. In addition, each time a trigger signal is received, or each time a prescribed period of time has elapsed from when a trigger signal was received, the visible light information providing device changes information to be provided.

Preferably, in the fifth aspect of the present invention, when information from an external information source is written to the information storage, the visible light information providing device provides the information written to the information storage.

Preferably, in the fifth aspect of the present invention, the visible light pattern is represented by the blinking pattern of light emitted from the light emitter, the color of light emitted from the light emitter, or a combination of the color and blinking pattern of light emitted from the light emitter.

Preferably, in the fifth aspect of the present invention, the visible light information reader further includes an information acquisition section for obtaining information from a server via a network. The information acquisition section obtains information from the server based on information in the form of a visible light pattern received from the visible light information providing device.

In accordance with the sixth aspect of the present invention, there is provided a visible light information providing system comprising: at least one visible light information providing device including a network interface, a light emitter for emitting visible light, a visible light modulator for modulating visible light emitted from the light emitter to transmit information, a visible light pattern controller for controlling the light emitter to create a visible light pattern, and a trigger receiver for receiving a trigger signal from an external device; and a visible light information reader including a visible light receiver for receiving modulated visible light, and a visible light demodulator for demodulating visible light received by the visible light receiver. The visible light information reader further includes a trigger transmitter for transmitting a trigger signal to the visible light information providing device. When receiving a trigger signal from the visible light information reader, the visible light information providing device transmits information received through the network interface in the form of a visible light pattern under the control of the visible light pattern controller.

In accordance with the seventh aspect of the present invention, there is provided a visible light information providing method applied to a visible light information providing device including an information storage, a light emitter for emitting visible light, a visible light modulator for modulating visible light emitted from the light emitter to transmit information stored in the information storage, and a visible light pattern controller for controlling the light emitter to emit visible light in a prescribed pattern according to the type of information stored in the information storage. The visible light information providing method comprises the steps of controlling, by the visible light pattern controller, the light emitter to emit visible light in a prescribed pattern according to the type of information stored in the information storage, and emitting, by the light emitter, visible light in the prescribed pattern.

Preferably, in the seventh aspect of the present invention, the visible light information providing device further includes a trigger receiver for receiving a trigger signal from an external device. The visible light pattern controller exercises control over the light emitter only when the trigger receiver receives a trigger signal from an external device.

Preferably, in the seventh aspect of the present invention, when the information storage stores a plurality of types of information, the light emitter emits visible light patterns according to the respective types of the information. In addition, each time a trigger signal is received, or each time a prescribed period of time has elapsed from when a trigger signal was received, the visible light information providing device changes information to be provided.

Preferably, in the seventh aspect of the present invention, when information from an external information source is written to the information storage, the light emitter emits visible light in a pattern according to the type of the information written to the information storage.

Preferably, in the seventh aspect of the present invention, the pattern of visible light is represented by the blinking pattern of light emitted from the light emitter, the color of light emitted from the light emitter, or a combination of the color and blinking pattern of light emitted from the light emitter.

In accordance with the eighth aspect of the present invention, there is provided a visible light information providing method applied to a visible light information providing device including a network interface, a light emitter for emitting visible light, a visible light modulator for modulating visible light emitted from the light emitter to transmit information, and a visible light pattern controller for controlling the light emitter to create a visible light pattern. The visible light information providing method comprises the steps of controlling, by the visible light pattern controller, the light emitter to create a visible light pattern according to the type of information received through the network interface, and transmitting, by the visible light modulator, information received through a network.

In accordance with the ninth aspect of the present invention, there is provided a program implementing a visible light information providing method with a computer that controls the operation of a visible light information providing device including an information storage, a light emitter for emitting visible light, a visible light modulator for modulating visible light emitted from the light emitter to transmit information stored in the information storage, and a visible light pattern controller for controlling the light emitter to emit visible light in a prescribed pattern according to the type of information stored in the information storage. The program is operable to cause the computer to emit from the light emitter visible light in a prescribed pattern according to the type of information stored in the information storage.

Preferably, in the ninth aspect of the present invention, the visible light information providing device further includes a trigger receiver for receiving a trigger signal from an external device. The program causes the computer to emit from the light emitter visible light in a prescribed pattern according to the type of information stored in the information storage when the trigger receiver receives a trigger signal from an external device.

Preferably, in the ninth aspect of the present invention, when the information storage stores a plurality of types of information, the program causes the computer to emit visible light patterns according to the respective types of the information. In addition, each time a trigger signal is received, or each time a prescribed period of time has elapsed from when a trigger signal was received, the program causes the computer to change information to be provided.

Preferably, in the ninth aspect of the present invention, when information from an external information source is written to the information storage, the program causes the computer to provide the information written to the information storage.

Preferably, in the ninth aspect of the present invention, the pattern of visible light is represented by the blinking pattern of light emitted from the light emitter, the color of light emitted from the light emitter, or a combination of the color and blinking pattern of light emitted from the light emitter.

In accordance with the tenth aspect of the present invention, there is provided a program implementing a visible light information providing method with a computer that controls the operation of a visible light information providing device including a network interface, a light emitter for emitting visible light, a visible light modulator for modulating visible light emitted from the light emitter to transmit information, a visible light pattern controller for controlling the light emitter to create a visible light pattern, and a trigger receiver for receiving a trigger signal from an external device. The program is operable to cause the computer to transmit information received through the network interface in the form of a visible light pattern by the visible light pattern controller.

In accordance with the eleventh aspect of the present invention, there is provided a computer-readable information storage medium for storing the visible light information providing program in the ninth or tenth aspect of the present invention.

As is described above, in accordance with the present invention, visible light is used to forward data stored in a memory or obtained through a network to another device. Besides, the user is provided with such information as to whether or not any data is stored in the memory (whether or not any data has been received via the network), and the type of data stored therein (the type of data received via the network) by the same light source as used for transmitting data.

Since rays of visible light are easily intercepted by opaque materials and also hardly diffracted, the reach of the light rays can be limited to the desired range. Moreover, the area where a signal reaches can be checked by human eyes without any special device. Consequently, it is possible to prevent signal waves from reaching to an undesired area, and thereby to prevent information leaks. Further, the user is provided with information by the same light source as used for transmitting data. Therefore, a visible light information providing device can be smaller and lighter.

Thus, there can be provided a visible light information providing device, a visible light information reader, a visible light information providing system, a visible light information providing method, a program thereof, and a computer-readable information storage medium for storing the program, enabling a user to recognize the area to which information is provided in a contactless manner.

### BRIEF DESCRIPTION OF THE DRAWINGS

The exemplary aspects and features of the present invention will become more apparent from the consideration of the following detailed description taken in conjunction with the accompanying drawings in which:

FIG. 1 is a block diagram showing the construction of a conventional RF tag system;

FIG. 2 is a diagram showing the construction of an optical tag according to the first embodiment of the present invention;

FIG. 3 (a) is a diagram showing examples of the radiation pattern of an LED;

FIG. 3 (b) is a diagram showing an example of a radiation pattern table;

FIG. 4 is a diagram showing an example of a radiation pattern table for indicating the types of data by different-colored lights when an optical tag has an LED with a plurality of colors;

FIG. 5 (a) is a diagram showing examples of the radiation pattern of an LED array;

FIG. 5 (b) is a diagram showing another example of a radiation pattern table;

FIG. 6 (a) is a diagram showing examples of the radiation pattern of an LED matrix;

FIG. 6 (b) is a diagram showing yet another example of a radiation pattern table;

FIG. 7 is a block diagram showing the construction of an optical tag according to the second embodiment of the present invention;

FIG. 8 is a block diagram showing the construction of an optical tag according to the third embodiment of the present invention;

FIG. 9 is a block diagram showing the construction of an optical tag system according to the fourth embodiment of the present invention;

FIG. 10 is a diagram showing examples of changes in the radiation pattern of an LED when a plurality of types of data are stored in a memory;

FIG. 11 is a sequence diagram showing an example of the operation of the optical tag system according to the fourth embodiment;

FIG. 12 is a block diagram showing the construction of a visible light information providing system according to the fifth embodiment of the present invention;

FIG. 13 is a block diagram showing the construction of a visible light information providing system according to the sixth embodiment of the present invention;

FIG. 14 is a diagram showing the correspondence between the types of data and the radiation patterns of an LED;

FIG. 15 is a block diagram showing the construction of an optical tag system according to the seventh embodiment of the present invention; and

FIG. 16 is a sequence diagram showing an example of the operation of the optical tag system according to the seventh embodiment.

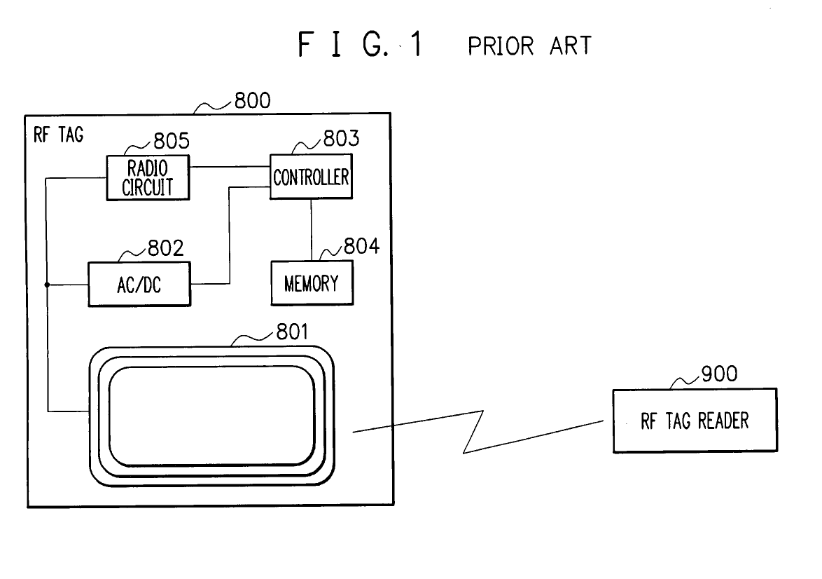

### DESCRIPTION OF THE PREFERRED EMBODIMENTS

Referring now to the drawings, a description of preferred embodiments of the present invention will be given in detail.

### First Embodiment

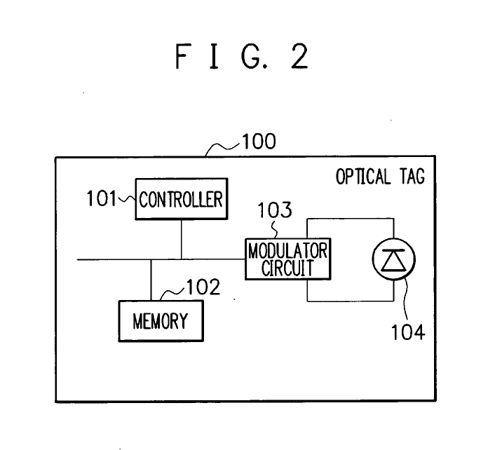

FIG. 2 is a diagram showing the construction of an optical tag according to the first embodiment of the present invention. Referring to FIG. 2, the optical tag 100 comprises a controller 101, a memory 102, a modulator circuit 103, and an LED (Light Emitting Diode) 104.

The controller 101 controls the operation of the optical tag 100 to forward information to an optical tag reader. The controller 101 is generally provided with a CPU (Central Processing Unit), a ROM (Read Only Memory) storing a program that causes the CPU to perform prescribed operations, and a RAM (Random Access Memory) as a work area for the CPU. The memory 102 stores data read by the optical tag reader (data to be forwarded) in a nonvolatile manner. The modulator circuit 103 outputs a control signal to the LED 104 in response to an instruction from the controller 101 to turn on or off the LED 104. The LED 104 is a light source that emits visible light for forwarding information to the optical tag reader. The LED 104 is switched on or off according to a control signal received from the modulator circuit 103.

The power source of the optical tag 100 may be a storage battery (not shown) or a loop antenna (not shown) excited contactlessly from the outside. If a loop antenna is employed as the power source, the controller 101 operates only while being supplied with power from the loop antenna.

In the following, the operation of the optical tag 100 will be described. When the memory 102 stores no data, the controller 101 deactivates the modulator circuit 103 to prevent the LED 104 from illuminating. On the other hand, when the memory 102 stores data, the controller 101 activates the modulator circuit 103 so that the LED 104 emits light in a prescribed pattern.

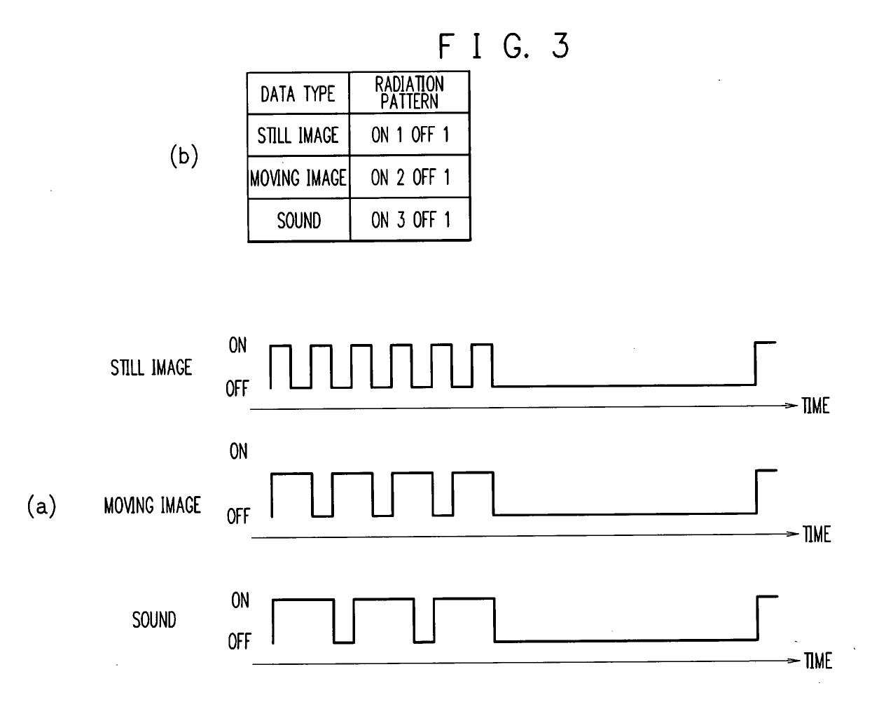

FIG. 3 (a) is a diagram showing examples of the radiation or illumination pattern of the LED 104. FIG. 3 (b) is a diagram showing an example of the radiation pattern table. As can be seen in FIG. 3 (a), a different radiation pattern is allocated to each type of information stored in the memory 102. The radiation patterns are stored in the ROM (not shown) of the controller 101 as a radiation pattern table shown in FIG. 3 (b).

In the case where the memory 102 stores information, the controller 101 activates the modulator circuit 103 according to a radiation pattern defined in the radiation pattern table to cause the LED 104 to light. By virtue of this construction, the user can recognize whether or not any information is stored in the optical tag 100 and also the type of the information stored therein without any special device.

The area irradiated with light emitted from the LED 104 is predetermined depending on the type of the LED 104. Incidentally, a light shielding plate may be set in the vicinity of the light-emitting surface of the LED 104 to arbitrarily define the area irradiated with light.

As is described above, in accordance with the first embodiment of the present invention, the optical tag 100 uses visible light to send information stored in the memory 102 to the optical tag reader. Since rays of visible light do not penetrate through opaque materials, the reach of the light rays can be easily limited to the desired range. Consequently, the information is unlikely to leak even if transmitted contactlessly.

In addition, the user is provided with information as to whether or not any data is stored in the memory 102 and the like by the LED 104 used for forwarding information to the optical tag reader. Therefore, the optical tag 100 can be smaller and lighter.

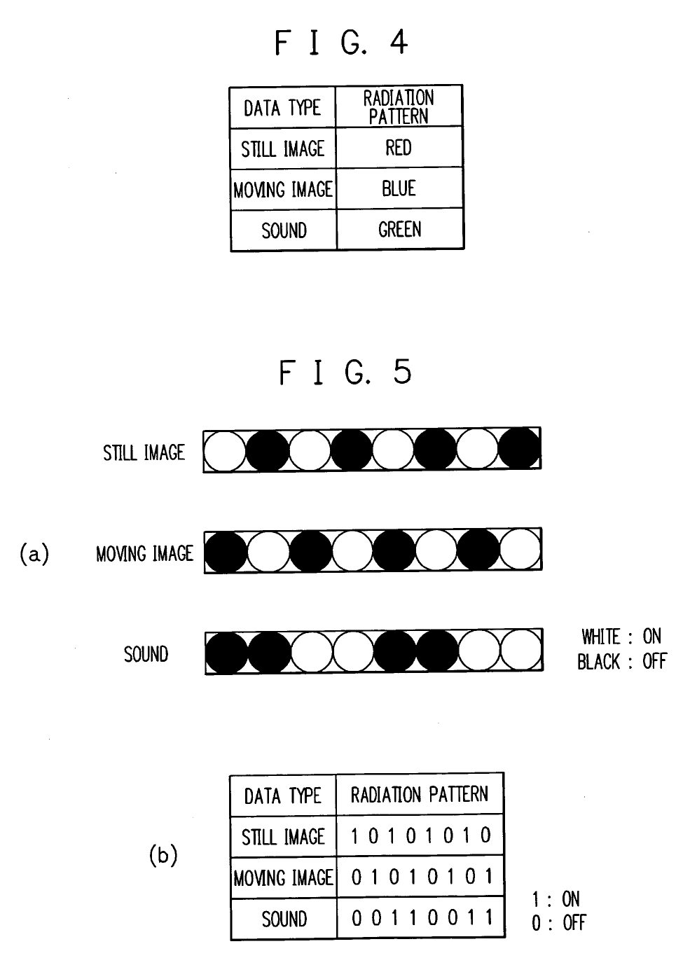

FIG. 4 is a diagram showing an example of a radiation pattern table for indicating the types of data by different-colored lights. In the above description, the blinking pattern of the LED is cited as an example of the radiation pattern. However, in the case where the optical tag is provided with an LED with a plurality of colors, the type of data may be indicated by a difference in color as shown in FIG. 4.

FIG. 5 (a) is a diagram showing examples of the radiation pattern of an LED array. In the case where the optical tag is provided with an LED array consisting of a plurality of LEDs, the type of data may be indicated by the lighting of the respective LEDs as shown in FIG. 5 (a). FIG. 5 (b) is a diagram showing a radiation pattern table stored in the ROM in this case.

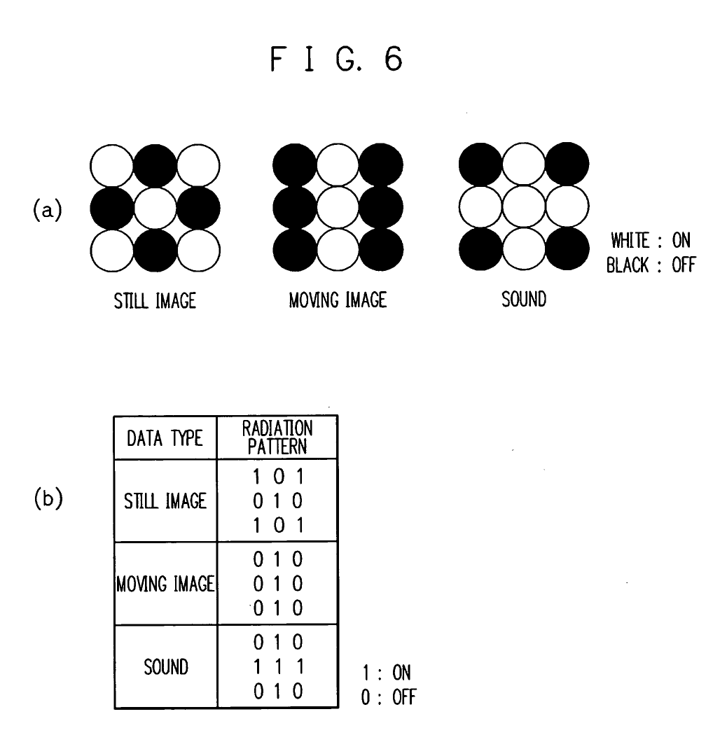

FIG. 6 (a) is a diagram showing examples of the radiation pattern of an LED matrix. In the case where the optical tag is provided with an LED matrix consisting of a plurality of LEDs, the type of data may be indicated by the lighting of the respective LEDs as shown in FIG. 6 (a). FIG. 6 (b) is a diagram showing a radiation pattern table stored in the ROM in this case.

### Second Embodiment

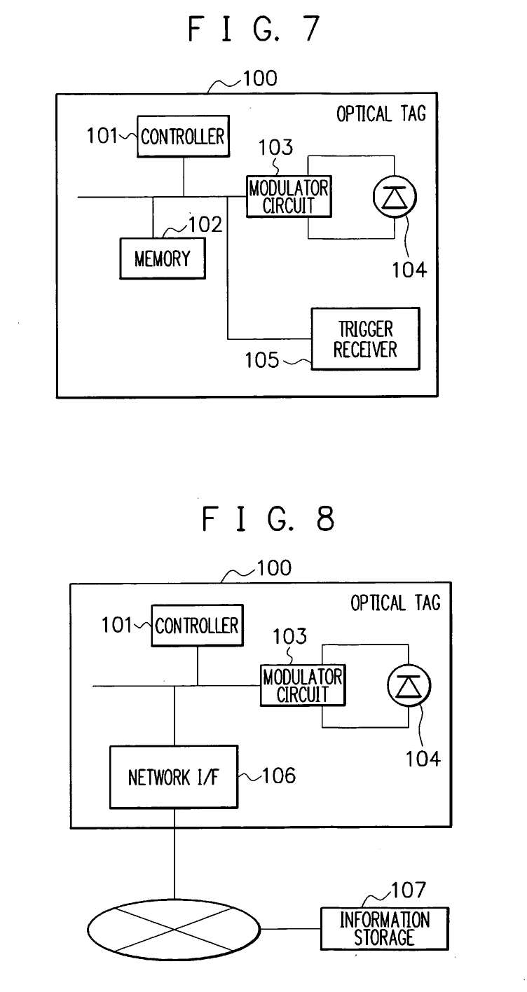

FIG. 7 is a block diagram showing the construction of an optical tag according to the second embodiment of the present invention. The optical tag 100 of the second embodiment is basically similar in construction to that of the first embodiment except for the presence of a trigger receiver 105.

The trigger receiver 105 is a circuit for receiving a trigger signal from an external device. In this embodiment, the controller 101 exercises control over the modulator circuit 103 to cause the LED 104 to emit a visible light pattern only when the trigger receiver 105 receives a trigger signal.

By virtue of this construction, the LED 104 does not unnecessarily emit a visible light pattern. Thereby, electric power consumption can be reduced.

### Third Embodiment

FIG. 8 is a block diagram showing the construction of an optical tag according to the third embodiment of the present invention. The optical tag 100 of the third embodiment comprises, similarly to that of the first embodiment, the controller 101, the modulator circuit 103 and the LED 104. The optical tag 100 does not include the memory 102, but includes a network interface (network I/F) 106 in place of the memory 102. The optical tag 100 receives information sent via a network from an information storage 107 on the network through the network interface 106. That is, in this embodiment, an information storage built in the optical tag 100 of the first embodiment as the memory 102 is provided outside the optical tag 100 as the information storage 107. From this point of view, the optical tag 100 of the third embodiment is equivalent in construction to that of the first embodiment.

In the following, the operation of the optical tag 100 of this embodiment will be described. When the optical tag 100 has received no information from the information storage 107 on the network (when the information storage 107 stores no information), the controller 101 deactivates the modulator circuit 103 to prevent the LED 104 from illuminating. On the other hand, when the optical tag 100 has received information from the information storage 107 (when the information storage 107 stores information), the controller 101 activates the modulator circuit 103 so that the LED 104 emits light in a prescribed pattern corresponding to the received information. There may be applied the same radiation patterns as described previously for the first embodiment.

Although the optical tag 100 of the third embodiment has essentially the same construction as that of the first embodiment except for the presence of the network interface 106 in place of the memory 102, the optical tag 100 may include, similarly to that of the second embodiment, the trigger receiver.

### Fourth Embodiment

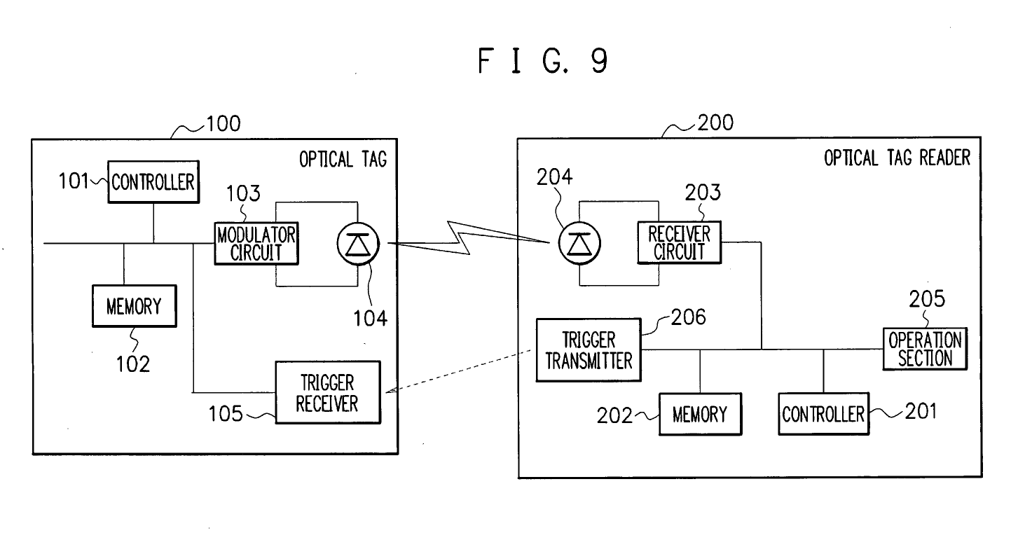

FIG. 9 is a block diagram showing the construction of an optical tag system according to the fourth embodiment of the present invention. Referring to FIG. 9, the optical tag system comprises an optical tag 100 and an optical tag reader 200.

The optical tag system of this embodiment employs the same optical tag 100 as described previously for the second embodiment.

The optical tag reader 200 includes a controller 201, a memory 202, a receiver circuit 203, a light receiving element or a PDIO (Photodiode) 204, an operation section 205, and a trigger transmitter 206.

The controller 201 controls the operation of the optical tag reader 200 to transmit/receive data to/from the optical tag 100. The controller 201 is generally provided with a CPU, a ROM storing a program that causes the CPU to perform prescribed operations, and a RAM as a work area for the CPU. The memory 202 stores information obtained from the optical tag 100. The receiver circuit 203 converts an electrical signal, originally an optical signal sent from the optical tag 100, to digital data. The PDIO 204 is a device that convents a received optical signal to an electrical signal. The operation section 205 is an interface for the user to provide input when the optical tag reader 200 reads data stored in the optical tag 100. The trigger transmitter 206 sends a trigger signal to the optical tag 100 according to input provided by the user through the operation section 205.

The controller 201 activates the trigger transmitter 206 according to input provided by the user through the operation section 205 to transmit a trigger signal to the optical tag 100.

When the trigger receiver 105 receives a trigger signal sent from the optical tag reader 200, the trigger signal is input to the controller 101. The controller 101 activates the modulator circuit 103 in response to the trigger signal to cause the LED 104 to light. The LED 104 emits light in a pattern corresponding to the type of data stored in the memory 102 as in the first embodiment.

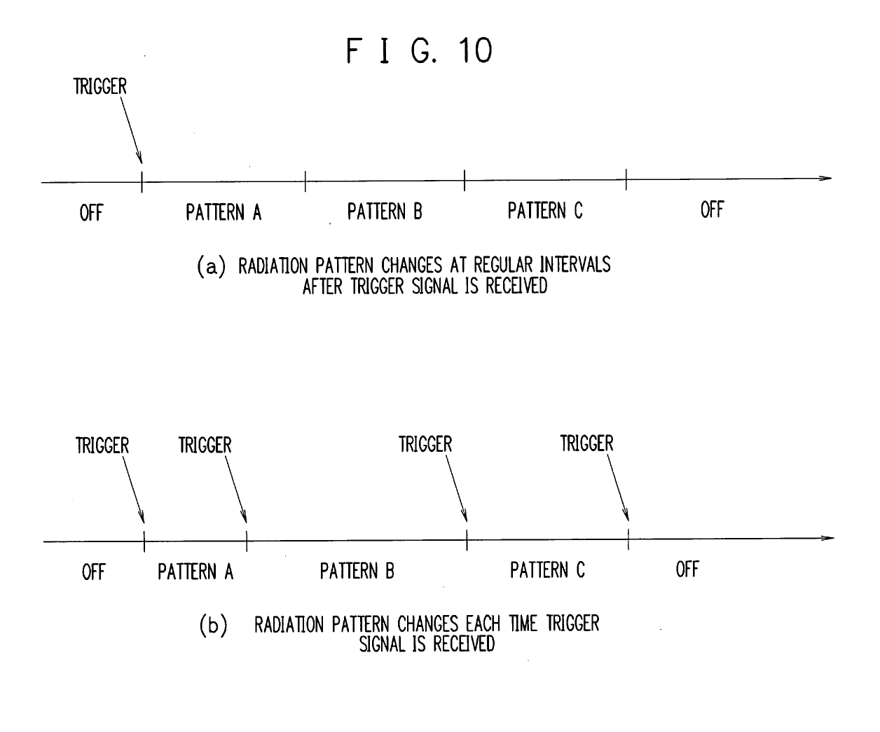

FIG. 10 is a diagram showing examples of changes in the radiation pattern of the LED 104 when a plurality of types of data are stored in the memory 102. FIG. 10 (a) illustrates the case where the controller 101 changes the radiation pattern of the LED 104 at regular intervals after the optical tag 100 receives a trigger signal. FIG. 10 (b) illustrates the case where the controller 101 changes the radiation pattern of the LED 104 each time the optical tag 100 receives a trigger signal. Preferably, the controller 101 turns off the LED 104 when the optical tag 100 receives neither a trigger signal nor a data transmission request within a prescribed period of time after receiving the last trigger signal.

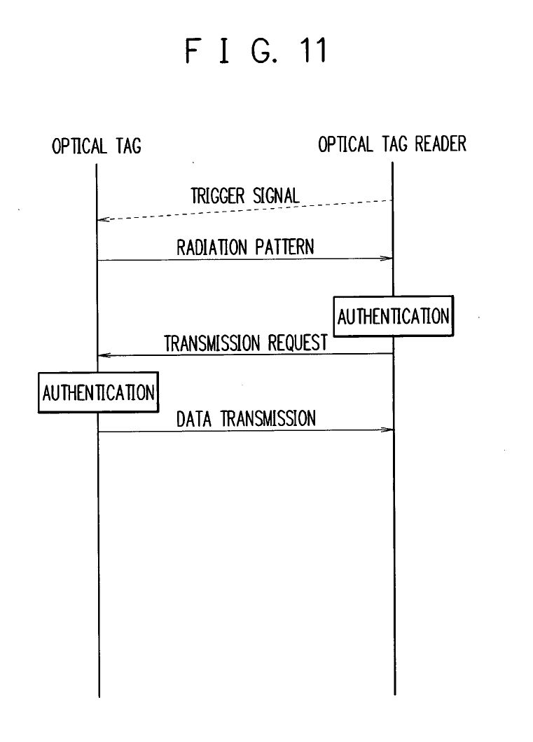

FIG. 11 is a sequence diagram showing an example of the operation of the optical tag system according to the fourth embodiment.

In response to a trigger signal from the optical tag reader 200, the LED 104 of the optical tag 100 emits light in a prescribed pattern. Having received a data transmission request from the optical tag reader 200 while the LED 104 is emitting light in a prescribed pattern, the optical tag 100 authenticates the optical tag reader 200 which is a sender of the data transmission request. If the authentication is successful, data corresponding to the radiation pattern of the LED 104 is read out from the memory 102. The data is input to the modulator circuit 103 to generate an electrical signal. The LED 104 is activated according to the generated electrical signal to transmit data to the optical tag reader 200.

For example, when the optical tag 100 receives a data transmission request from the optical tag reader 200 while the LED 104 is emitting light in pattern A under the control of the controller 101, the controller 101 reads data corresponding to pattern A out of the memory 102. Subsequently, the controller 101 feeds the data to the modulator circuit 103 to convert it to an electrical signal. After that, the controller 101 transmits the data from the LED 104 as an optical signal.

When the optical tag reader 200 receives the optical signal from the optical tag 100, the PDIO 204 convents the optical signal to an electrical signal. The receiver circuit 203 decodes or restores the electrical signal to its original form (original data). In this manner, the optical tag reader 200 reads out information stored in the memory 102 of the optical tag 100.

As is described above, in the optical tag system according to the fourth embodiment of the present invention, the optical tag 100 uses visible light to send information stored in the memory 102 to the optical tag reader 200. Since rays of visible light do not penetrate through opaque materials, the reach of the light rays can be easily limited to the desired range. Consequently, the information is unlikely to leak even if transmitted contactlessly.

In addition, the user of the optical tag system can obtain information as to whether or not any data is stored in the optical tag 100 and the type of information stored therein without any special device. Further, the optical tag 100 informs the user whether or not any data is stored in the memory 102 and the like by the LED 104 used for forwarding information to the optical tag reader 200. Therefore, the optical tag 100 can be smaller and lighter.

Although the optical tag system of the fourth embodiment employs the same optical tag as described previously for the second embodiment, the optical tag system may utilize the same optical tag as that of the third embodiment being additionally provided with the trigger receiver. That is, the optical tag 100 may not include the memory 102, and an information storage may be provided outside the optical tag 100 instead.

### Fifth Embodiment

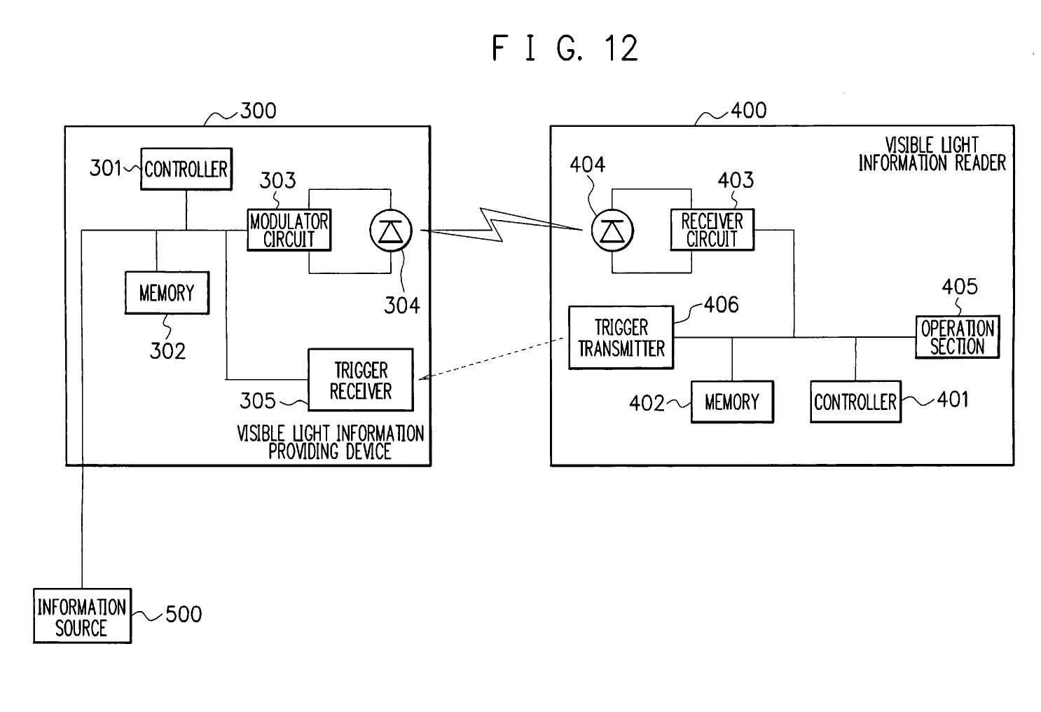

FIG. 12 is a block diagram showing the construction of a visible light information providing system according to the fifth embodiment of the present invention. Referring to FIG. 12, the visible light information providing system comprises a visible light information providing device 300, a visible light information reader 400, and an information source 500.

The visible light information providing device 300 and the visible light information reader 400 are basically similar in construction to the optical tag 100 and the optical tag reader 200 of the fourth embodiment, respectively. However, differently from the optical tag 100 and the optical tag reader 200, the visible light information providing device 300 and the visible light information reader 400 are not standalone devices known as “tag”, and data stored in their memories are rewritable from the outside.

The visible light information providing device 300 comprises a controller 301, a memory 302, a modulator circuit 303, an LED 304, and a trigger receiver 305, which correspond to the controller 101, the memory 102, the modulator circuit 103, the LED 104, and the trigger receiver 105 of the second embodiment, respectively.

Besides, the visible light information reader 400 comprises a controller 401, a memory 402, a receiver circuit 403, a PDIO 404, an operation section 405, and a trigger transmitter 406, which correspond to the controller 201, the memory 202, the receiver circuit 203, the PDIO 204, the operation section 205, and the trigger transmitter 206 of the fourth embodiment, respectively.

The information source 500 is a device to rewrite data stored in the memory 302 of the visible light information providing device 300. Examples of the information source 500 include a computer terminal, a server, and a PDA (Personal Digital Assistance).

In this embodiment, when the information source 500 adds or updates data in the memory 302, the LED 304 of the visible light information providing device 300 emits light in a prescribed pattern to inform the user of the addition or update of data in the memory 302.

As is described above, in the visible light information providing system according to the fifth embodiment of the present invention, the visible light information providing device 300 uses visible light to send information stored in the memory 302 to the visible light information reader 400. Since rays of visible light do not penetrate through opaque materials, the reach of the light rays can be easily limited to the desired range. Consequently, the information is unlikely to leak even if transmitted contactlessly.

Incidentally, the visible light information providing device 300 may include, similarly to the optical tag 100 of the third embodiment, a network interface in place of the memory 302, and an information storage may be provided outside the visible light information providing device 300. In this case, the user is informed that information stored in the information storage provided outside the visible light information providing device 300 has been rewritten.

### Sixth Embodiment

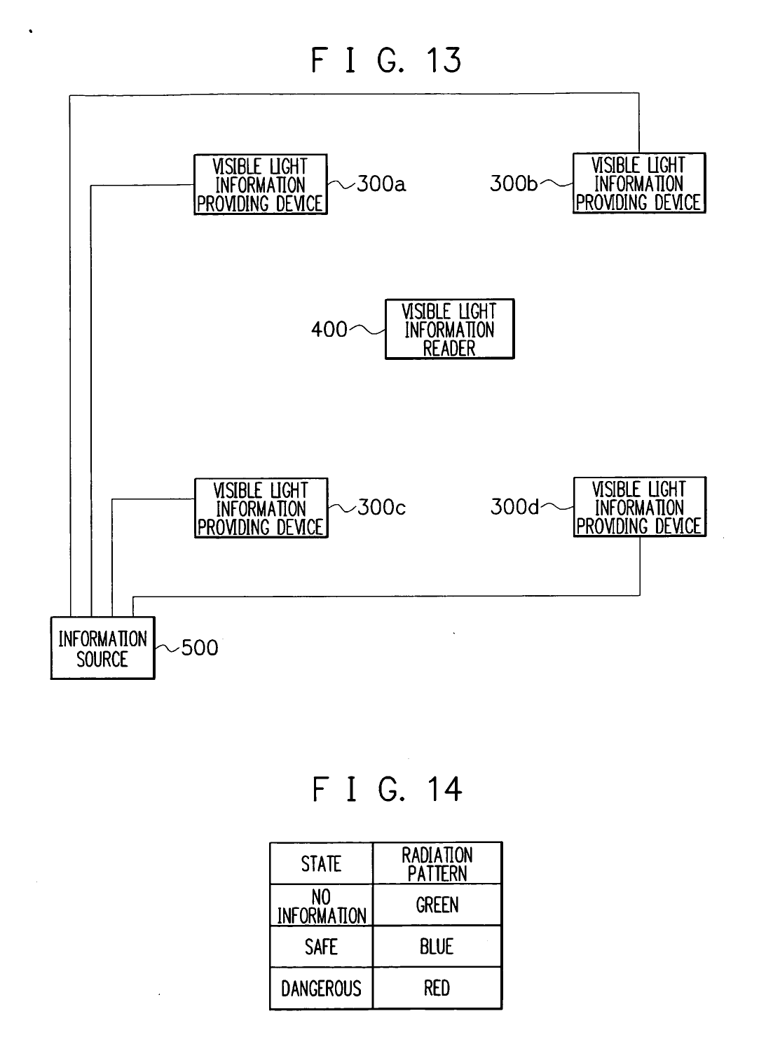

FIG. 13 is a block diagram showing the construction of a visible light information providing system according to the sixth embodiment of the present invention. The visible light information providing system of the sixth embodiment is provided with a plurality of the visible light information providing devices 300 differently from that of the fifth embodiment. While, in this embodiment, the visible light information providing system includes four visible light information providing devices 300a to 300d, the number of the devices is cited merely by way of example and without limitation.

In the following, a description will be given of the operation of the visible light information providing system in the case, as an specific example, where the visible light information providing devices 300 are used for escape route illumination or as emergency exit sign lighting. It will be assumed that each of the visible light information providing devices 300a to 300d is set on a door: the entrance or exit of a room, and previously stores a radiation pattern table shown in FIG. 14. In FIG. 14, “safe” means that escape is possible or that it is safe to go outside through the door provided with the visible light information providing device 300 as emergency exit sign lighting that emits light in a pattern corresponding to “safe”. On the other hand, “dangerous” means that escape is impossible or that it is dangerous to go outside through the door provided with the visible light information providing device 300 as emergency exit sign lighting that emits light in a pattern corresponding to “dangerous”.

When an accident or a disaster occurs, the visible light information providing device 300 receives as input information on the disaster from the information source 500. In the case, for example, where a route to the outside through the door where the visible light information providing device 300b is set is not passable, the visible light information providing devices 300a to 300d receive as input the information and image data indicating an escape route through each of the doors to outside the building from the information source 500.

The controller 301 of the visible light information providing device 300 refers to the information which the information source 500 has stored in the memory 302 to cause the LED 304 to emit light in a prescribed pattern. In the above example, the controllers 301a, 301c and the 301d let the LEDs 304a, 304c and the 304d illuminate blue, while the controller 301b lets the LED 304b illuminate red. Thereby, only the visible light information providing device 300b emits light in a pattern indicating “danger”. Having seen the emergency exit sign lighting, people can recognize that escape is impossible if going outside through the door provided with the visible light information providing device 300b.

The visible light information reader 400 reads data from any of the visible light information providing devices 300a, 300c and 300d in the same manner as described previously for the second embodiment. The user of the visible light information reader 400 refers to the image data which the visible light information reader 400 has obtained from any of the visible light information providing devices 300a, 300c and the 300d. Thus, the user can escape the disaster promptly.

As is described above, in the visible light information providing system according to the fourth embodiment of the present invention, the visible light information providing device stores information indicating its state (in this case, information as to whether or not escape is possible through the door provided with the device) in real time. By virtue of this construction, even when the environment where the visible light information providing system is set changes, the user can view and recognize the visible light information providing device that stores desired information.

Incidentally, as with the fifth embodiment, information is unlikely to leak even if transmitted contactlessly.

In addition, the visible light information providing device 300 may include, similarly to the optical tag 100 of the third embodiment, a network interface in place of the memory 302.

### Seventh Embodiment

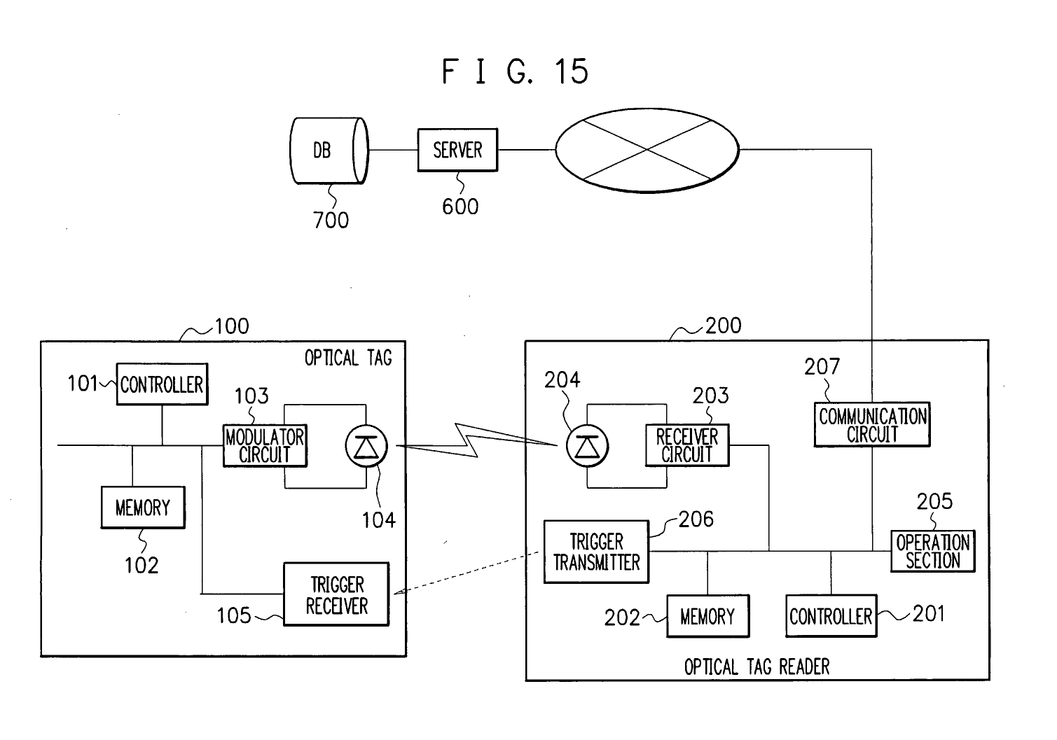

FIG. 15 is a block diagram showing the construction of an optical tag system according to the seventh embodiment of the present invention.

The optical tag system of the seventh embodiment is basically similar in construction to that of the fourth embodiment except that the optical tag reader 200 further includes a communication circuit 207 that is connected via a network to a server 600. Besides, the server 600 is connected to a database (DB) 700.

The connection between the communication circuit 207 and the network may be wired or wireless.

In this embodiment, the memory 102 of the optical tag 100 stores only an optical tag ID. The optical tag ID is unique information, which uniquely identifies the optical tag 100. The database 700 stores information associated with the optical tag ID. Based on the optical tag ID, the server 600 reads information associated therewith from the database 700.

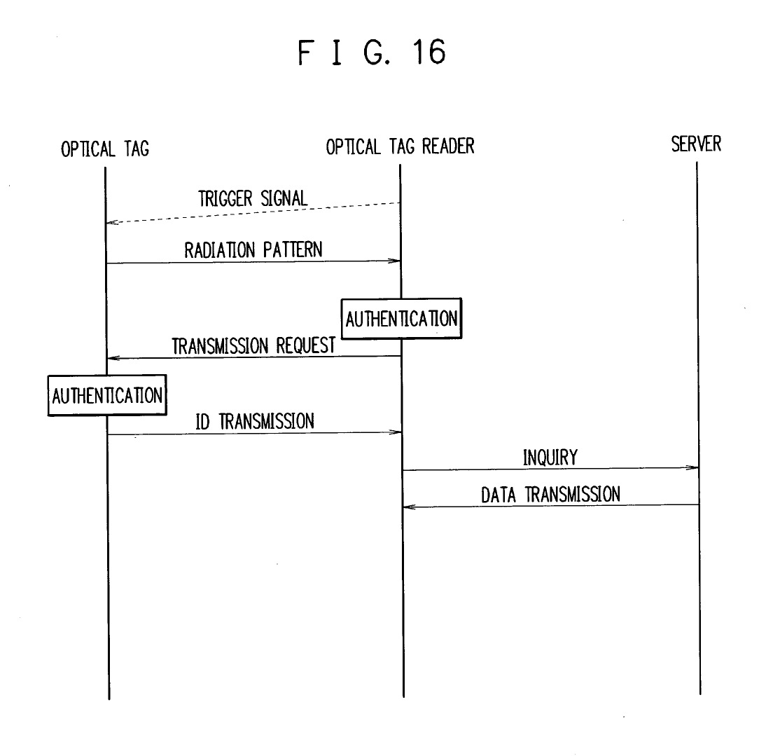

In the following, the operation of the optical tag system of this embodiment will be described. FIG. 16 is a sequence diagram showing an example of the operation of the optical tag system according to the seventh embodiment.

The optical tag system of this embodiment operates in the same manner as that of the second embodiment until the optical tag reader 200 reads out the information (optical tag ID) stored in the memory 102 of the optical tag 100.

Having obtained the optical tag ID from the optical tag 100, the controller 201 of the optical tag reader 200 transmits it to the server 600 via the network. The server 600 obtains information stored in the database 700 which is associated with the optical tag ID received from the optical tag reader 200. The server 600 transmits the information obtained from the database 700 to the optical tag reader 200.

Thus, the optical tag reader 200 acquires the information associated with the information (optical tag ID) stored in the optical tag 100.

In the seventh embodiment, the reach of the light rays can also be easily limited to the desired range. Consequently, information is unlikely to leak even if transmitted contactlessly.

Further, in the optical tag system according to the seventh embodiment, only the optical memory (tag) ID is transmitted/received with the use of optical signals. Therefore, even if the optical signals are intercepted or monitored, the information stored in the database 700 does not leak out.

While the optical tag 100 of the seventh embodiment includes the memory 102, it may be provided with a network interface, as described previously for the third embodiment, and connected to an information storage through a network.

While the preferred embodiments of the present invention have been described using specific terms, such description is for illustrative purposes only and without limitation.

For example, in the above embodiments, the controllers of the visible light information providing device (optical tag) and the visible light information reader (optical tag reader) each have a CPU, and the CPU executes a program stored in ROM in RAM as a work area for the CPU. However, the DSP (Digital Signal Processor) may also be employed.

As set forth hereinabove, in accordance with the present invention, visible light is utilized to forward data stored in a memory or obtained through a network to another device. Besides, the user is provided with such information as to whether or not any data is stored in the memory (whether or not any data has been received via the network), and the type of data stored therein (the type of data received via the network) by the same light source as used for transmitting data.

Since rays of visible light are easily intercepted by opaque materials and also hardly diffracted, the reach of the light rays can be limited to the desired range. Moreover, the area where a signal reaches can be checked by human eyes without any special device. Consequently, it is possible to prevent signal waves from reaching to an undesired area, and thereby to prevent information leaks. Further, the user is provided with information by the same light source as used for transmitting data. Therefore, a visible light information providing device can be smaller and lighter.

While the present invention has been described with reference to the particular illustrative embodiments, it is not to be restricted by the embodiments but only by the appended claims. It is to be appreciated that those skilled in the art can change or modify the embodiments without departing from the scope and spirit of the present invention.

What is claimed is:

1. A visible light information providing device comprising:
an information storage;
a light emitter for emitting visible light;
a visible light modulator for modulating visible light emitted from the light emitter to transmit information stored in the information storage; and
a visible light pattern controller for controlling the light emitter to emit visible light in a prescribed pattern according to the type of information stored in the information storage.

2. The visible light information providing device claimed in claim 1, further comprising a trigger receiver for receiving a trigger signal from an external device, wherein the visible light pattern controller exercises control over the light emitter when the trigger receiver receives a trigger signal from an external device.

3. The visible light information providing device claimed in claim 1, wherein when the information storage stores a plurality of types of information, the light emitter emits visible light patterns according to the respective types of the information.

4. The visible light information providing device claimed in claim 2, wherein each time a trigger signal is received, information to be provided is changed.

5. The visible light information providing device claimed in claim 2, wherein each time a prescribed period of time has elapsed from when a trigger signal was received, information to be provided is changed.

6. The visible light information providing device claimed in claim 1, wherein when information from an external information source is written to the information storage, the information written to the information storage is provided.

7. The visible light information providing device claimed in claim 1, wherein the pattern of visible light is represented by the blinking pattern of the light emitter.

8. The visible light information providing device claimed in claim 1, wherein the pattern of visible light is represented by the color of light emitted from the light emitter.

9. The visible light information providing device claimed in claim 1, wherein the pattern of visible light is represented by a combination of the color and blinking pattern of light emitted from the light emitter.

10. A visible light information providing device comprising:
a network interface;
a light emitter for emitting visible light;
a visible light modulator for modulating visible light emitted from the light emitter to transmit information; and
a visible light pattern controller for controlling the light emitter to create a visible light pattern;
wherein the visible light pattern controller controls the light emitter to create a visible light pattern according to the type of information received through the network interface; and
the visible light modulator transmits information received through a network.

11. A visible light information reader comprising:
a visible light receiver for receiving modulated visible light;
a visible light demodulator for demodulating visible light received by the visible light receiver; and
a trigger transmitter for transmitting to a visible light information providing device a trigger signal causing visible light to be emitted in a pattern according to the type of information stored in an information storage in the visible light information providing device.

12. A visible light information reader comprising:
a visible light receiver for receiving modulated visible light;
a visible light demodulator for demodulating visible light received by the visible light receiver; and
a trigger transmitter for transmitting to a visible light information providing device a trigger signal causing a visible light pattern to be emitted according to the type of information received through a network interface by the visible light information providing device.

13. A visible light information providing system comprising at least one visible light information providing device and a visible light information reader, wherein:
the visible light information providing device includes:
an information storage;
a light emitter for emitting visible light;
a visible light modulator for modulating visible light emitted from the light emitter to transmit information stored in the information storage;
a visible light pattern controller for controlling the light emitter to emit visible light in a prescribed pattern according to the type of information stored in the information storage; and
a trigger receiver for receiving a trigger signal from an external device;
a visible light information reader includes:
a visible light receiver for receiving modulated visible light;
a visible light demodulator for demodulating visible light received by the visible light receiver; and
a trigger transmitter for transmitting a trigger signal to the visible light information providing device; and
when receiving a trigger signal from the visible light information reader, the visible light information providing device transmits information stored in the information storage under the control of the visible light pattern controller.

14. The visible light information providing system claimed in claim 13, wherein when the information storage stores a plurality of types of information, visible light patterns are emitted according to the respective types of the information.

15. The visible light information providing system claimed in claim 14, wherein each time a trigger signal is received, the visible light information providing device changes information to be provided.

16. The visible light information providing system claimed in claim 14, wherein each time a prescribed period of time has elapsed from when a trigger signal was received, the visible light information providing device changes information to be provided.

17. The visible light information providing system claimed in claim 13, wherein when information from an external information source is written to the information storage, the visible light information providing device provides the information written to the information storage.

18. The visible light information providing system claimed in claim 13, wherein the pattern of visible light is represented by the blinking pattern of the light emitter.

19. The visible light information providing system claimed in claim 13, wherein the pattern of visible light is represented by the color of light emitted from the light emitter.

20. The visible light information providing system claimed in claim 13, wherein the pattern of visible light is represented by a combination of the color and blinking pattern of light emitted from the light emitter.

21. The visible light information providing system claimed in claim 13, wherein:
the visible light information reader further includes an information acquisition section for obtaining information from a server via a network; and
the information acquisition section obtains information from the server based on information in the form of a visible light pattern received from the visible light information providing device.

22. A visible light information providing system comprising at least one visible light information providing device and a visible light information reader, wherein:
the visible light information providing device includes:
a network interface;
a light emitter for emitting visible light;
a visible light modulator for modulating visible light emitted from the light emitter to transmit information;
a visible light pattern controller for controlling the light emitter to create a visible light pattern; and
a trigger receiver for receiving a trigger signal from an external device;
the visible light information reader includes:
a visible light receiver for receiving modulated visible light;
a visible light demodulator for demodulating visible light received by the visible light receiver; and
a trigger transmitter for transmitting a trigger signal to the visible light information providing device; and
when receiving a trigger signal from the visible light information reader, the visible light information providing device transmits information received through the network interface in the form of a visible light pattern under the control of the visible light pattern controller.

23. A visible light information providing method applied to a visible light information providing device including an information storage, a light emitter for emitting visible light, a visible light modulator for modulating visible light emitted from the light emitter to transmit information stored in the information storage, and a visible light pattern controller for controlling the light emitter to emit visible light in a prescribed pattern according to the type of information stored in the information storage, the method comprising the steps of:
controlling, by the visible light pattern controller, the light emitter to emit visible light in a prescribed pattern according to the type of information stored in the information storage; and
emitting, by the light emitter, visible light in the prescribed pattern.

24. The visible light information providing method claimed in claim 23, wherein:
the visible light information providing device further includes a trigger receiver for receiving a trigger signal from an external device; and
the visible light pattern controller exercises control over the light emitter when the trigger receiver receives a trigger signal from an external device.

25. The visible light information providing method claimed in claim 23, wherein when the information storage stores a plurality of types of information, the light emitter emits visible light patterns according to the respective types of the information.

26. The visible light information providing method claimed in claim 24, wherein each time a trigger signal is received, the visible light information providing device changes information to be provided.

27. The visible light information providing method claimed in claim 24, wherein each time a prescribed period of time has elapsed from when a trigger signal was received, the visible light information providing device changes information to be provided.

28. The visible light information providing method claimed in claim 23, wherein when information from an external information source is written to the information storage, the information written to the information storage is provided.

29. The visible light information providing method claimed in claim 23, wherein the pattern of visible light is represented by the blinking pattern of the light emitter.

30. The visible light information providing method claimed in claim 23, wherein the pattern of visible light is represented by the color of light emitted from the light emitter.

31. The visible light information providing method claimed in claim 23, wherein the pattern of visible light is represented by a combination of the color and blinking pattern of light emitted from the light emitter.

32. A visible light information providing method applied to a visible light information providing device including a network interface, a light emitter for emitting visible light, a visible light modulator for modulating visible light emitted from the light emitter to transmit information, and a visible light pattern controller for controlling the light emitter to create a visible light pattern, the method comprising the steps of:
controlling, by the visible light pattern controller, the light emitter to create a visible light pattern according to the type of information received through the network interface; and
transmitting, by the visible light modulator, information received through a network.

33. A program implementing a visible light information providing method with a computer that controls the operation of a visible light information providing device including an information storage, a light emitter for emitting visible light, a visible light modulator for modulating visible light emitted from the light emitter to transmit information stored in the information storage, and a visible light pattern controller for controlling the light emitter to emit visible light in a prescribed pattern according to the type of information stored in the information storage, the program being operable to cause the computer to emit from the light emitter visible light in a prescribed pattern according to the type of information stored in the information storage.

34. The program claimed in claim 33, wherein:
the visible light information providing device further includes a trigger receiver for receiving a trigger signal from an external device; and
the computer causes the light emitter to emit visible light in a prescribed pattern according to the type of information stored in the information storage when the trigger receiver receives a trigger signal from an external device.

35. The program claimed in claim 33, wherein when the information storage stores a plurality of types of information, the computer causes the light emitter to emit visible light patterns according to the respective types of the information.

36. The program claimed in claim 34, wherein each time a trigger signal is received, the computer changes information to be provided.

37. The program claimed in claim 34, wherein each time a prescribed period of time has elapsed from when a trigger signal was received, the computer changes information to be provided.

38. The program claimed in claim 33, wherein when information from an external information source is written to the information storage, the computer provides the information written to the information storage.

39. The program claimed in claim 33, wherein the pattern of visible light is represented by the blinking pattern of the light emitter.

40. The program claimed in claim 33, wherein the pattern of visible light is represented by the color of light emitted from the light emitter.

41. The program claimed in claim 33, wherein the pattern of visible light is represented by a combination of the color and blinking pattern of light emitted from the light emitter.

42. A program implementing a visible light information providing method with a computer that controls the operation of a visible light information providing device including a network interface, a light emitter for emitting visible light, a visible light modulator for modulating visible light emitted from the light emitter to transmit information, a visible light pattern controller for controlling the light emitter to create a visible light pattern, and a trigger receiver for receiving a trigger signal from an external device, the program being operable to cause the computer to transmit information received through the network interface in the form of a visible light pattern by the visible light pattern controller.

43. A computer-readable information storage medium for storing the visible light information providing program claimed in claim 33.
